(19) United States
(12) Patent Application Publication
(10) Pub. No.: US 2015/0144809 A1
(43) Pub. Date: May 28, 2015

(54) TARGET SUPPLY DEVICE AND EXTREME ULTRAVIOLET LIGHT GENERATION APPARATUS

(71) Applicant: GIGAPHOTON INC., Tochigi (JP)

(72) Inventors: Shinji OKAZAKI, Tochigi (JP); Takanobu ISHIHARA, Tochigi (JP); Yutaka SHIRAISHI, Tochigi (JP)

(21) Appl. No.: 14/611,914

(22) Filed: Feb. 2, 2015

Related U.S. Application Data
(63) Continuation of application No. PCT/JP2013/071215, filed on Aug. 6, 2013.

(30) Foreign Application Priority Data
Aug. 8, 2012 (JP) 2012-176253

(51) Int. Cl. H05G 2/00

(52) U.S. Cl. CPC H05G 2/006; H05G 2/008; H05G 2/005
USPC 250/504 R; 222/566

(57) ABSTRACT

A target supply device may include: a tank including a storage portion that stores a target material and a supply portion that is in communication with the storage portion, the target material flowing into the supply portion; a nozzle including a nozzle hole that is in communication with the supply portion to be fed with the target material; and a coating portion that covers a wall surface of the nozzle hole.

### CROSS-REFERENCE TO RELATED APPLICATIONS

This application claims priority to Application No. PCT/JP2013/071215 filed on Aug. 6, 2013, which application claims priority to Japanese Application No. 2012-176253, filed on Aug. 8, 2012. The entire contents of the above applications are incorporated herein by reference in their entireties.

### BACKGROUND

1. Technical Field

The present disclosure relates to a device that supplies a target to be irradiated by a laser light for generating extreme ultraviolet (EUV) light. Further, the present disclosure relates to an apparatus for generating EUV light using the target supply device.

2. Related Art

In recent years, semiconductor production processes have become capable of producing semiconductor devices with increasingly fine feature sizes, as photolithography has been making rapid progress toward finer fabrication. In the next generation of semiconductor production processes, microfabrication with feature sizes at 70 nm to 45 nm, and further, microfabrication with feature sizes of 32 nm or less will be required. In order to meet the demand for microfabrication with feature sizes of 32 nm or less, for example, an exposure apparatus is needed in which a system for generating EUV light at a wavelength of approximately 13 nm is combined with a reduced projection reflective optical system.

Three kinds of systems for generating EUV light are known in general, which include a Laser Produced Plasma (LPP) type system in which plasma is generated by irradiating a target material with a laser beam, a Discharge Produced Plasma (DPP) type system in which plasma is generated by electric discharge, and a Synchrotron Radiation (SR) type system in which orbital radiation is used to generate plasma.

### SUMMARY

A target supply device may include:

a tank including a storage portion that is configured to store a target material and a supply portion that is in communication with the storage portion so that the target material flows into the supply portion;

a nozzle including a nozzle hole that is in communication with the supply portion and is configured to be fed with the target material; and

a coating portion that covers a wall surface of the nozzle hole.

### BRIEF DESCRIPTION OF THE DRAWINGS

Hereinafter, selected exemplary embodiments of the present disclosure will be described with reference to the accompanying drawings.

FIG. 1 schematically illustrates an exemplary configuration of an LPP-type EUV light generation apparatus.

FIG. 2 schematically illustrates a configuration of a target supply device according to a first exemplary embodiment.

FIG. 3 illustrates a vicinity of a nozzle 72 of the target supply device 7 according to the first exemplary embodiment in an enlarged manner.

FIG. 4 illustrates a vicinity of the nozzle 72 of the target supply device 7 according to a second exemplary embodiment in an enlarged manner.

FIG. 5 illustrates a vicinity of the nozzle 72 of the target supply device 7 according to a third exemplary embodiment in an enlarged manner.

FIG. 6 illustrates a vicinity of the nozzle 72 of the target supply device 7 according to a fourth exemplary embodiment in an enlarged manner.

FIG. 7 illustrates a shape of the nozzle 72 of the target supply device 7 according to the fourth exemplary embodiment.

FIG. 8 illustrates a shape of the nozzle 72 of the target supply device 7 according to a fifth exemplary embodiment.

FIG. 9 illustrates a shape of the nozzle 72 of the target supply device 7 according to a sixth exemplary embodiment.

FIG. 10 illustrates the target supply device 7 according to a seventh exemplary embodiment.

FIG. 11 illustrates an output side of the target supply device 7 according to the seventh exemplary embodiment.

FIG. 12 illustrates a filter 9 used in the target supply device 7 according to the seventh exemplary embodiment.

FIG. 13 illustrates a modification of the target supply device 7 according to the seventh exemplary embodiment.

FIG. 14 illustrates the target supply device 7 according to an eighth exemplary embodiment.

### DETAILED DESCRIPTION

### Contents

### 1. Overview

2. Explanation of terms

### 3. Overall Description of EUV Light Generation Apparatus

3.1 Configuration

3.2 Operation

### 4. EUV Light Generation System Including Target Supply Device

4.1 Configuration

4.2 Operation

### 5. Target Supply Device Including Coating

### 6. Combination of Material of Tank and Nozzle and Material of Coating Portion

### 7. Shape of Nozzle

### 8. Target Supply Device Including Coated Filter

9. Target Supply Device Including Coated in-Tank Component

Hereinafter, selected exemplary embodiments of the present disclosure will be described in detail with reference to the accompanying drawings. The exemplary embodiments to be described below are merely illustrative in nature and do not limit the scope of the present disclosure. Further, the configuration(s) and operation(s) described in each embodiment are not all essential in implementing the present disclosure. Note that like elements are referenced by like reference numerals and characters, and duplicate descriptions thereof will be omitted herein.

### 1. Overview

In an LPP type EUV light generation apparatus, a target material in a form of a droplet may be outputted from a nozzle hole of a target supply device into a chamber. The target supply device may be controlled so that the droplet reaches a plasma generation region in the chamber at a predetermined timing. A pulse laser beam may be irradiated to the droplet when the droplet reaches the plasma generation region, so that the target material may be turned into plasma and an EUV light may be emitted from the plasma.

When the target is liquid tin (Sn), a high-melting-point metal such as molybdenum (Mo) may be used as a material of a tank and a nozzle of a target supply portion. However, the metal such as molybdenum (Mo) may react with the target material such as tin (Sn) to form an alloy. When the metal such as molybdenum (Mo) and the metal such as tin (Sn) are reacted to form an alloy in the nozzle hole for outputting the droplet, the nozzle hole may be clogged by the alloy. When a part of the nozzle hole is clogged, the output direction of the target material may be changed to lower the performance of the EUV light generation apparatus.

Alternatively, when the target is liquid tin (Sn), a non-metal material such as quartz glass and ceramics that is unlikely to react with liquid tin (Sm) may be used as the material of the tank and the nozzle of the target supply portion. It should be noted, however, that a non-metal material may be low in capacity for keeping pressure resistance of the tank and the nozzle of the target supply portion as compared with a metal material.

Accordingly, a target supply device 7 according to the exemplary embodiments of the present disclosure may include a coating portion 8 at a region of the tank 71 and the nozzle 72 possibly in contact with the target material in a form of liquid tin (Sn).

### 2. Explanation of Terms

Some of the terms used in the present application will be explained below. A “chamber” is a container for isolating a plasma-generation space of an LPP-type EUV light generation apparatus from an outside. A “target supply device” is a device for supplying a target material such as molten tin used for generating the EUV light into the chamber. An “EUV collector mirror” is a mirror that reflects an EUV light emitted from plasma and outputs the EUV light to the outside of the chamber. A “debris” is a material including neutral particles of the target material (i.e. the target material not turned into plasma) supplied into the chamber and ion particles emitted from the plasma. The debris causes contamination or damage of optical devices such as the EUV collector mirror.

### 3. Overall Description of EUV Light Generation Apparatus

3.1 Configuration

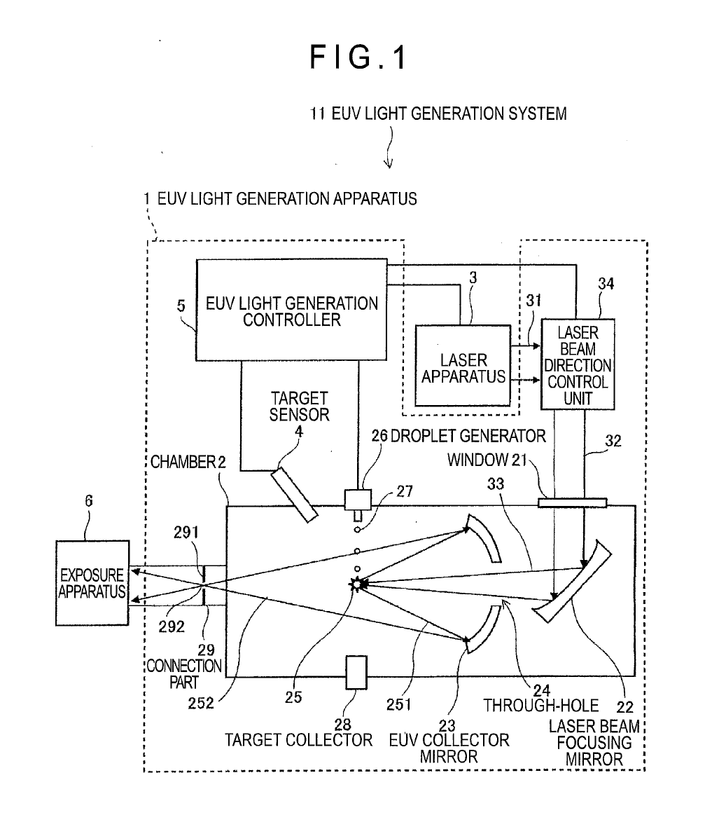

FIG. 1 schematically illustrates an exemplary configuration of an LPP-type EUV light generation apparatus. An EUV light generation apparatus 1 may be used with at least one laser apparatus 3. Hereinafter, a system that includes the EUV light generation apparatus 1 and the laser apparatus 3 may be referred to as an EUV light generation system 11. As shown in FIG. 1 and described in detail below, the EUV light generation apparatus 1 may include a chamber 2 and the target supply device. The target supply device may be a droplet generator 26, for example. The chamber 2 may be sealed airtight. The target supply device may be mounted on a wall of the chamber 2. A target material to be supplied by the target supply device may include, but is not limited to, tin (Sn), or a combination of tin and any one or more of terbium, gadolinium, lithium and xenon.

The chamber 2 may have at least one through-hole formed in its wall, and a pulse laser beam 32 outputted from the laser apparatus 3 may travel through the through-hole. Alternatively, the chamber 2 may have at least one window 21, through which the pulse laser beam 32 outputted by the laser apparatus 3 is adapted to travel. An EUV collector mirror 23 having, for example, a spheroidal reflective surface may be provided in the chamber 2. The EUV collector mirror 23 may have a first focus and a second focus. The EUV collector mirror 23 may have a multi-layered reflective film on the surface thereof formed by alternately laminating molybdenum and silicon layers. The EUV collector mirror 23 may preferably be positioned so that the first focus lies in or near a plasma generation region 25 and the second focus lies at a desired focus position defined by the specifications of an exposure apparatus. The desired focus position may be an intermediate focus (IF) 292. The EUV collector mirror 23 may have a through-hole 24 formed at the center thereof so that a pulse laser beam 33 may travel through the through-hole 24.

The EUV light generation apparatus 1 may further include an EUV light generation controller 5. The EUV light generation apparatus 1 may further include a target sensor 4. The target sensor 4 may detect at least one of the presence, trajectory and position of the target. The target sensor 4 may have an imaging function.

Further, the EUV light generation apparatus 1 may include a connection part 29 for bringing the interior of the chamber 2 in communication with the interior of an exposure apparatus 6. A wall 291 having an aperture may be provided in the connection part 29. The wall 291 may be positioned so that the second focus of the EUV collector mirror 23 lies in the aperture formed in the wall 291.

Further, the EUV light generation apparatus 1 may also include a laser beam direction control unit 34, a laser beam focusing mirror 22, and a target collector 28 for collecting a target 27. In order to control a travel direction of the laser beam, the laser beam direction control unit 34 may include an optical element for defining the direction into which the pulse laser beam travels and an actuator for adjusting the position or posture of the optical element.

3.2 Operation

With continued reference to FIG. 1, a pulse laser beam 31 outputted from the laser apparatus 3 may pass through the laser beam direction control unit 34 and be outputted therefrom as the pulse laser beam 32 through the window 21 into the chamber 2. The pulse laser beam 32 may travel inside the chamber 2 along at least one beam path from the laser apparatus 3, be reflected by the laser beam focusing mirror 22, and strike at least one target 27 as the pulse laser beam 33.

The droplet generator 26 may output the target 27 to the plasma generation region 25 inside the chamber 2. The target 27 may be irradiated with at least one pulse of the pulse laser beam 33. Upon being irradiated with the pulse laser beam 33, the target 27 may be turned into plasma, and EUV light 251 may be emitted from the plasma. The EUV light 251 may be reflected to be collected by the EUV collector mirror 23. An EUV light 252, which is the light reflected by the EUV collector mirror 23, may travel through the intermediate focus 292 and be outputted to the exposure apparatus 6. Here, the target 27 may be irradiated with multiple pulses included in the pulse laser beam 33.

The EUV light generation controller 5 may be configured to integrally control the EUV light generation system 11. The EUV light generation controller 5 may be configured to process image data and the like of the target 27 captured by the target sensor 4. The EUV light generation controller 5 may be configured to control at least one of the timing when the target 27 is outputted and the direction into which the target 27 is outputted. Furthermore, the EUV light generation controller 5 may be configured to control at least one of the timing when the laser apparatus 3 oscillates, the direction in which the pulse laser beam 32 travels, and the position at which the pulse laser beam 33 is focused. It will be appreciated that the various controls mentioned above are merely examples, and other controls may be added as necessary.

### 4. EUV Light Generation System Including Target Supply Device

### 4.1 Configuration

Next, the target supply device in a form of, for example, the droplet generator 26 shown in FIG. 1 will be described below.

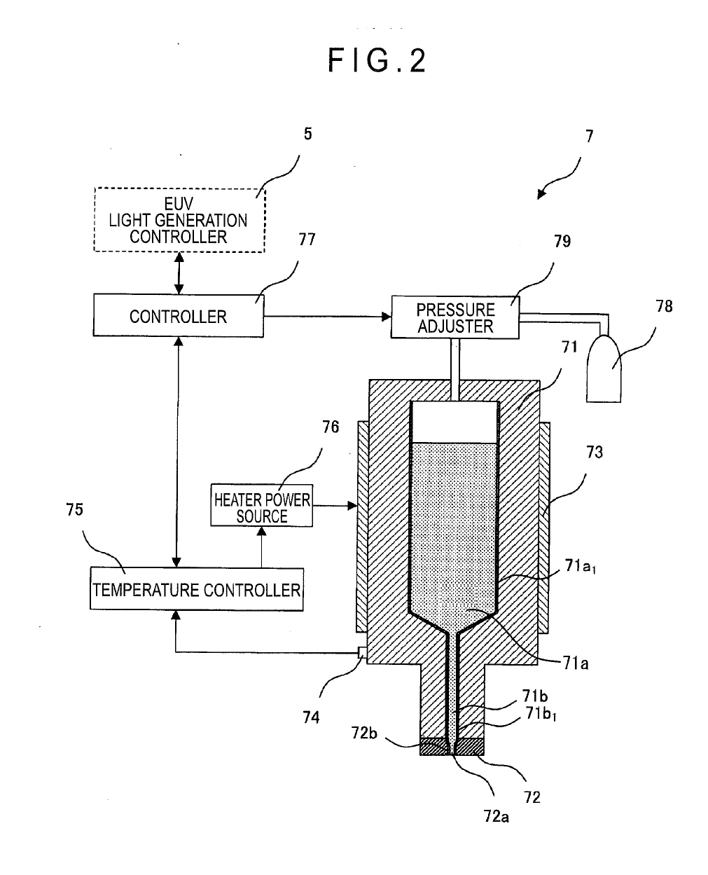

FIG. 2 illustrates the target supply device according to a first exemplary embodiment.

As shown in FIG. 2, the target supply device 7 according to the first exemplary embodiment may include a tank 71, a nozzle 72. a heater 73, a temperature sensor 74, a temperature controller 75, a heater power source 76, a controller 77, an inert gas supply source 78 and a pressure adjuster 79.

The tank 71 may include a storage portion 71a and a supply portion 71b. The storage portion 71a may be defined including a wall surface 71a₁ inside the tank 71. The supply portion 71b may be defined including a wall surface 71b₁ inside a tube defined inside the tank 71 and connected to the storage portion 71a. The material of the tank 71 may be molybdenum (Mo) or tungsten (W).

The nozzle 72 may be attached to a leading end of the supply portion 71b of the tank 71. The nozzle 72 may include a nozzle hole 72a. The nozzle hole 72a may be connected to the supply portion 71b. The nozzle hole 72a may be circular. The nozzle hole 72a may be configured so that the diameter thereof becomes smaller from the supply portion 71b toward an output side. The diameter of the nozzle hole 72a at the leading end thereof may be in a range from several μm to 10 μm. The material of the nozzle 72 may be molybdenum (Mo) or tungsten (W). A piezoelectric element (not shown) may be attached to the nozzle 72.

The heater 73 may be attached to the tank 71. For example, the heater 73 may be attached to an outer circumference of the tank 71. The heater 73 may be connected to the heater power source 76. The heater power source 76 may be connected to the temperature controller 75.

The temperature sensor 74 may be attached to the tank 71. For example, the temperature sensor 74 may be attached to the outer circumference of the tank 71. The temperature sensor 74 may be connected to the temperature controller 75. The temperature controller 75 may be connected to the controller 77.

The inert gas supply source 78 may be connected through a piping to the storage portion 71a of the tank 71.

The pressure adjuster 79 may be disposed to the piping connecting the inert gas supply source 78 and the storage portion 71a. The pressure adjuster 79 may include a pressure sensor, an inlet valve and an outlet valve (all not shown). The pressure sensor may alternatively be disposed to the piping connected to the storage portion 71a to be connected to the pressure adjuster 79. Further, the pressure adjuster 79 may be connected to the controller 77.

### 4.2 Operation

Next, an operation of the target supply device 7 will be described below.

The controller 77 of the target supply device 7 may be configured to receive a target generation signal from the EUV light generation controller 5.

The controller 77 may send a signal indicating a target temperature to the temperature controller 75 so that the temperature of tin (Sn) in the storage portion 71a falls within a predetermined temperature range of the melting point (232° C.) of tin or higher. The predetermined temperature range may be from 280 to 350° C., for example. The temperature controller 75 may receive from the temperature sensor 74 a signal indicating the temperature of the tank 71 measured by the temperature sensor 74. The temperature controller 75 may send to the heater power source 76 a signal indicating the electric power to be supplied to the heater 73 based on the signal from the temperature sensor 74. As described above, the temperature controller 75 may control the individual components so that the temperature of the tank 71 becomes the target temperature indicated by the controller 77. The temperature controller 75 may send to the controller 77 a signal indicating the temperature of the tank 71 measured by the temperature sensor 74 as a signal indicating a control status.

The controller 77 may send a signal indicating a target pressure to the pressure adjuster 79 so as to apply a predetermined pressure to tin in the storage portion 71a. The predetermined pressure may be in a range from 1 to 10 MPa. The pressure adjuster 79 may receive a signal indicating the pressure inside the tank 71 from the pressure sensor. The pressure adjuster 79 may adjust the pressure of the inert gas in the storage portion 71a based on the signal from the pressure sensor with the use of the inlet valve and the outlet valve. The pressure adjuster 79 may send to the controller 77 a signal indicating the pressure inside the tank 71 measured by the pressure sensor as a signal indicating a control status.

### 5. Target Supply Device Including Coating

Next, the target supply device 7 including the coating portion 8 will be described below. The coating portion 8 of the target supply device 7 may be provided at the region of the tank 71 and the nozzle 72 possibly in contact with tin (Sn).

By providing the coating portion 8, the possibility for molybdenum (Mo) or tungsten (W) (material of the tank 71 and the nozzle 72) to react with tin (Sn) (target) to form an alloy may be reduced.

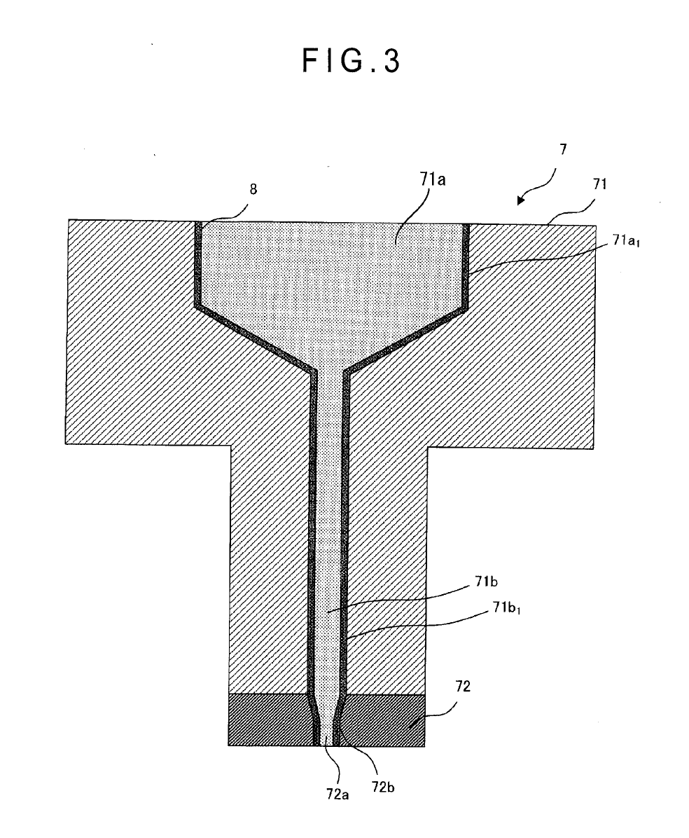

FIG. 3 illustrates a vicinity of the nozzle 72 of the target supply device 7 according to the first exemplary embodiment in an enlarged manner.

The coating portion 8 according to the first exemplary embodiment may be provided on the wall surface 71a₁ of the storage portion 71a of the tank 71, the wall surface 71b₁ of the supply portion 71b and a wall surface 72b of the nozzle hole 72a of the nozzle 72, all of which may be in contact with tin (Sn).

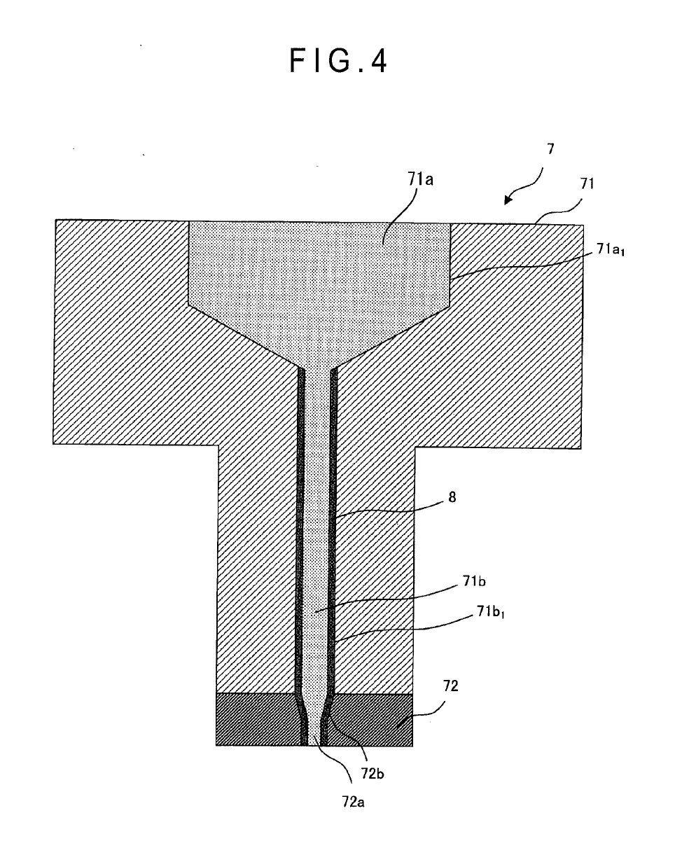

FIG. 4 illustrates a vicinity of the nozzle 72 of the target supply device 7 according to a second exemplary embodiment in an enlarged manner.

The coating portion 8 of the target supply device 7 according to the second exemplary embodiment may be provided on the wall surface 71b₁ of the supply portion 71b of the tank 71 and the wall surface 72b of the nozzle hole 72a of the nozzle 72, both of which may be in contact with tin (Sn).

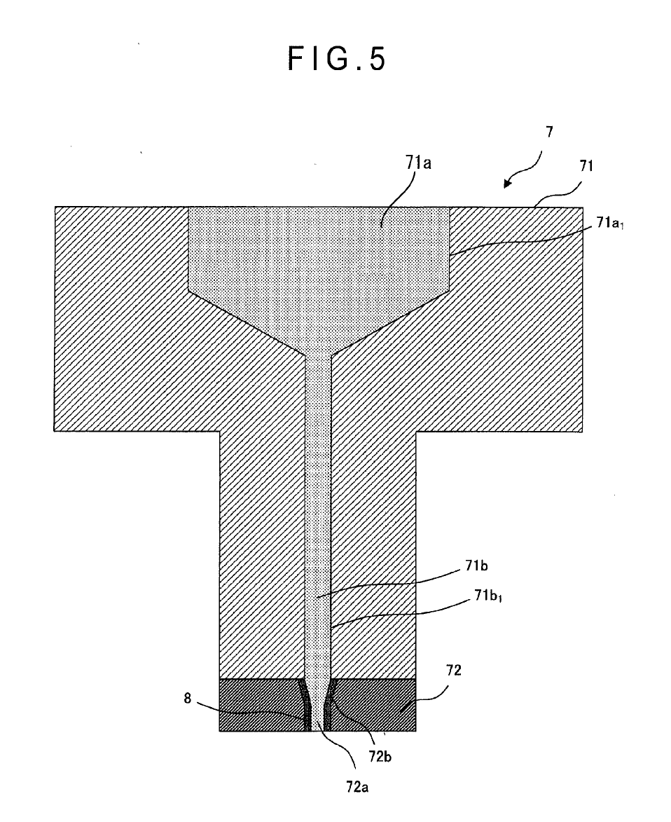

FIG. 5 illustrates a vicinity of the nozzle 72 of the target supply device 7 according to a third exemplary embodiment in an enlarged manner.

The coating portion 8 of the target supply device 7 according to the third exemplary embodiment may be provided on the wall surface 72b of the nozzle hole 72a of the nozzle 72, which may be in contact with tin (Sn).

FIG. 6 illustrates a vicinity of the nozzle 72 of the target supply device 7 according to a fourth exemplary embodiment in an enlarged manner.

The coating portion 8 of the target supply device 7 according to the fourth exemplary embodiment may be provided on the wall surface 72b and an outer surface 72c of the nozzle hole 72a of the nozzle 72, both of which may be in contact with tin (Sn).

### 6. Combination of Material of Tank and Nozzle and Material of Coating Portion

Next, a combination of the material of the tank 71 and the nozzle 72 and the material of the coating portion 8 will be described below.

Table 1 below shows a linear expansion coefficient, corrosion depth of tin (Sn) and corrosion resistance against tin (Sn) of each of the materials (see L. A. Lay, “Handbook of corrosion resistance of technical ceramics”, published by Kyoritsu Shuppan Co., Ltd. on Dec. 15, 1985, PP. 138-143).

TABLE 1

| | | | Corrosion- |
|---|---|---|---|
| | | | Resistant up |
| | | | to the Following |
| | | | Temperature |
| | Linear | Corrosion Depth | according |
| | Expansion | of Sn | to Non-Patent |
| | Coefficient | (Test Reulsts) | Literature |
| Material | [10⁻⁶/° C.] | [μm] | 1 [° C.] |
| 3Al2O3/2SiO2 | 5.0 | | 1300 (Ar) |
| Al2O3 | 7.2 | | 1830 (N2) |
| (polycrystal) | | | |
| Al2O3 | 5.0/6.7 | | |
| (monocrystal) | | | |
| SiC | 4.1 | 0 (vacuum) | 600 (Ar) |
| ZrC | 6.9 | | 350 |
| Si3N4 | 3.2 | | 300 |
| BN | 6.4 | | M |
| TiB2 | 7.8 | | M |
| SiO2 | 0.5 | 0 (vacuum) | 600 |
| Mo | 5.2 | 10 (vacuum) | |
| W | 4.6 | 1 (vacuum) | |
| SUS316 | 15.9 | >2000 (vacuum) | |

In Table 1, the corrosion depth of tin (Sn) represents a corrosion depth [μm] based on results of observations on surfaces of tin (Sn) after experiments in which each of the materials was immersed in molten tin (Sn) at a temperature of 1,100° C. for 100 hours. The sign “M” in the corrosion resistance against tin (Sn) represents that the coating materials hardly reacted until the coating materials were melted.

The material of the tank 71 and the nozzle 72 may be selected from at least one of molybdenum (Mo) and tungsten (W) that exhibit a smaller corrosion depth of tin (Sn) (i.e. a depth of corrosion as a result of reaction with tin (Sn) to form an alloy) than that of stainless steel and the like.

When molybdenum (Mo) and/or tungsten (W) is selected as the material of the tank 71 and the nozzle 72, silicon carbide (SiC) may be selected as the material of the coating portion 8 because silicon carbide has a linear expansion coefficient close to that of molybdenum (Mo) and tungsten (W), the corrosion depth of tin (Sn) to silicon carbide is zero and silicon carbide has corrosion resistance against tin (Sn) even at a high temperature.

The method for providing the coating portion 8 may be selected from any one of sputtering, CVD and plasma CVD.

A film stress of the material of the tank 71 and the nozzle 72 and the material of the coating portion 8 will be described below. The following formula represents a film stress.

σ=E(α1−α2)(Ta−Tb)

where:
σ denotes a stress [Pa] applied to the coating portion 8;

E denotes a Young's [Pa] modulus of the coating portion 8;

α1 denotes a linear expansion coefficient [/° C.] of the coating portion 8;

α2 denotes a linear expansion coefficient [/° C.] of the tank 71 and the nozzle 72;

Ta denotes a use temperature or film-formation temperature [° C.]; and

Tb denotes a room temperature [° C.].

When a tensile strength of the coating portion 8 or an adhesion strength of the coating portion 8 to the material(s) of the tank 71 and the nozzle 72 is greater than the film stress u, a peeling and/or cracking of the coating portion 8 may be restrained. In other words, the film stress u of the coating portion 8 may be set as small as possible.

For example, when the material of the tank 71 and the nozzle 72 is molybdenum (Mo) and the material of the coating portion 8 is silicon carbide (SiC), the equations of α1=4.1×10⁻⁶ [/° C.] and α2=5.2×10⁻⁶ [/° C.] may be satisfied. At this time, when the coating portion 8 is provided by sputtering, supposing that Tb=0° C. and the film-formation temperature is 300° C., σ can be calculated as σ=142 MPa. On the other hand, when the coating portion 8 is provided by CVD, supposing that the film-formation temperature is 1,300° C., σ can be calculated as σ=615 MPa. As described above, by providing the coating portion 8 by sputtering, the possibility for the coating portion 8 to be peeled off can be favorably reduced. Accordingly, sputtering may be used for providing the coating portion 8.

### 7. Shape of Nozzle

The nozzle 72 may be a plate-shaped member having the nozzle hole 72a at the center thereof.

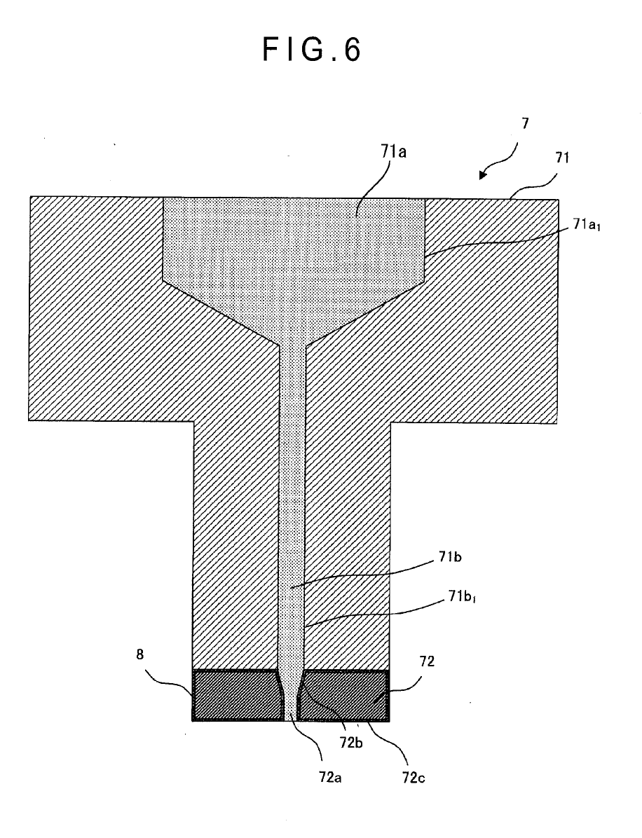

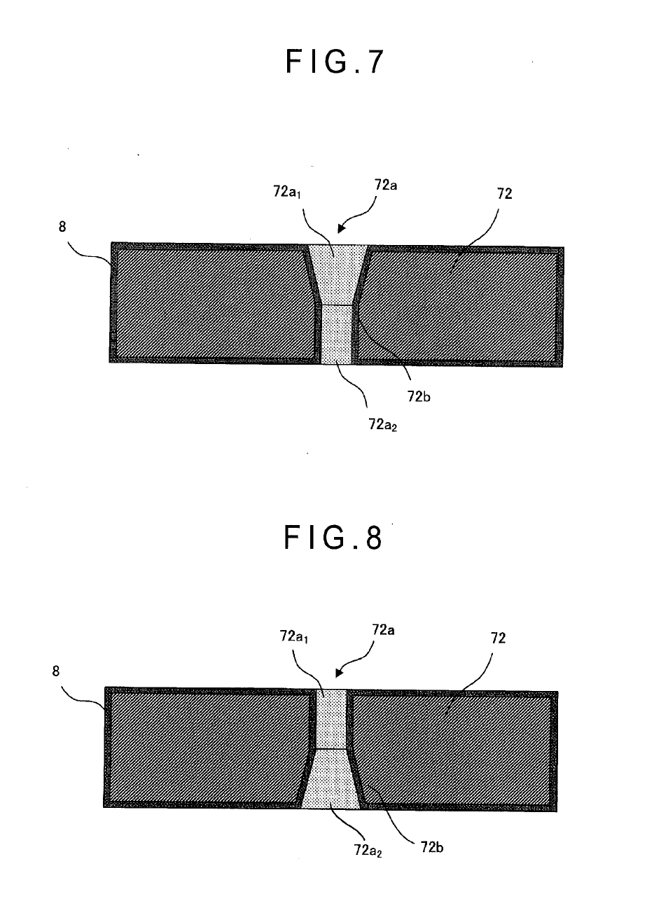

FIG. 7 illustrates the shape of the nozzle 72 of the target supply device 7 according to a fourth exemplary embodiment.

The nozzle hole 72a of the nozzle 72 of the target supply device 7 according to the fourth exemplary embodiment may have a tapered opening 72a₁ at a side near the tank 71. The tapered opening 72a₁ may be in communication with an output-side opening 72a₂ having a constant diameter (a constant-diameter portion).

When the coating portion 8 is provided by sputtering or the like, a ratio of the depth of the output-side opening 72a₂ to the diameter of the output-side opening 72a₂ may preferably be 2 or less. In the above configuration, the coating portion 8 may be provided on the nozzle 72 from both sides of the opening 72a₁ near the tank 71 and the output-side opening 72a₂. In this manner, the coating film is favorably easily provided also on the wall surface 72b of the output-side opening 72a₂. For example, when the diameter of the output-side opening 72a₂ is 10 μm, the depth of the output-side opening 72a₂ may be 20 μm. In the above, when the ratio of the depth of the constant-diameter portion of the nozzle hole 72a to the diameter of the constant-diameter portion of the nozzle hole 72a is defined as an “aspect ratio”, the aspect ratio may be 2.

When the nozzle 72 is formed of a plate-shaped member and the depth of the output-side opening 72a₂ is 20 μm, the thickness of the plate-shaped member can be favorably set at 20 μm. However, careful handling may be required for the nozzle 72 of 20 μm thick. Accordingly, the tapered portion may be provided to the opening 72a₁ near the tank 71 to increase the thickness and strength of the nozzle 72 and facilitate the handling of the nozzle 72.

FIG. 8 illustrates the shape of the nozzle 72 of the target supply device 7 according to a fifth exemplary embodiment.

The nozzle hole 72a of the nozzle 72 of the target supply device 7 according to the fifth exemplary embodiment may have the opening 72a₁ in the form of a constant-diameter portion at the side near the tank 71 and the tapered output-side opening 72a₂. In the above arrangement, since the nozzle hole 72a is not tapered at a side near the tank, concentration of impurities to the nozzle hole 72a can be favorably reduced. The tapered output-side opening 72a₂ may be used in a continuous jet method in which tin (Sn) is outputted in a jet.

When the output-side opening 72a₂ of the nozzle hole 72a is processed to be tapered, the aspect ratio of the constant-diameter portion is preferably 2 or less. In the above configuration, the coating portion 8 may be provided on the nozzle 72 from both sides of the opening 72a₁ near the tank 71 and the output-side opening 72a₂. In this manner, the coating film is favorably easily provided also on the wall surface 72b of the output-side opening 72a₂.

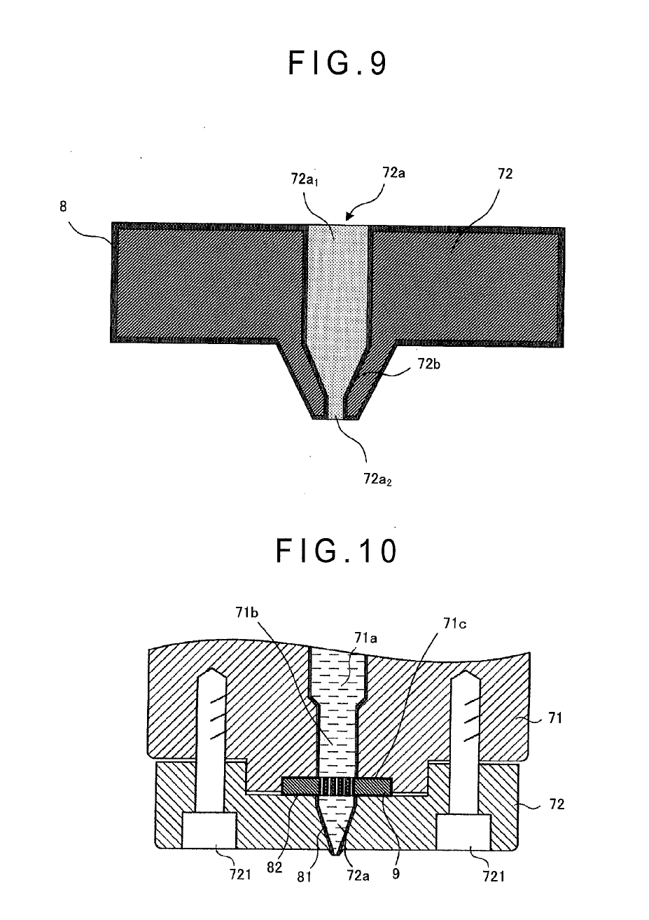

FIG. 9 illustrates the shape of the nozzle 72 of the target supply device 7 according to a sixth exemplary embodiment.

The nozzle hole 72a of the nozzle 72 of the target supply device 7 according to the sixth exemplary embodiment may have the output-side opening 72a₂ (a constant-diameter portion) that protrudes toward an output side. An electric field can be concentrated by the protruded nozzle 72, so that the nozzle 72 may be usable in an electrostatic drawer target supply device in which liquid tin (Sn) is drawn by Coulomb's force.

When the nozzle 72 is protruded toward the output side, the aspect ratio of the constant-diameter portion is preferably 2 or less. In the above configuration, the coating portion 8 may be provided on the nozzle 72 from both sides of the opening 72a₁ near the tank 71 and the output-side opening 72a₂. In this manner, the coating film is favorably easily provided also on the wall surface of the output-side opening 72a₂.

### 8. Target Supply Device Including Coated Filter

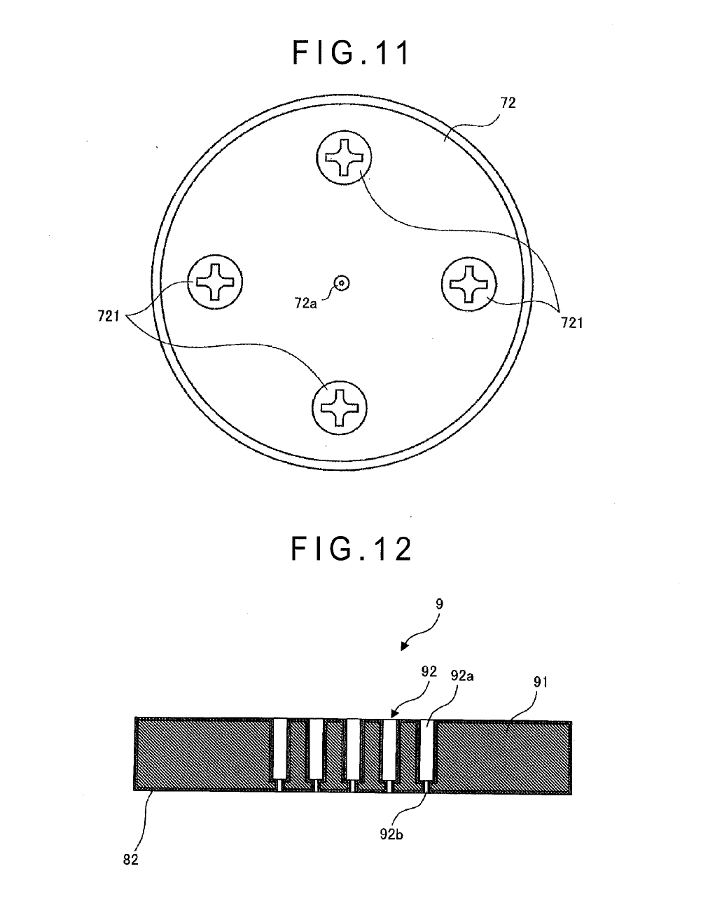

FIG. 10 illustrates the target supply device 7 according to a seventh exemplary embodiment. FIG. 11 illustrates an output side of the target supply device 7 according to the seventh exemplary embodiment.

The target supply device 7 according to the seventh exemplary embodiment may have a filter 9 between the supply portion 71b of the tank 71 and the nozzle hole 72a of the nozzle 72. The filter 9 may be disposed in a recessed portion 71c provided to a leading end of the supply portion 71b of the tank 71. The tank 71 and the nozzle 72 may be fastened by a bolt 721 after the filter 9 is disposed. The surface of the supply portion 71b of the tank 71 and the surface of the nozzle hole 72a of the nozzle 72 may be provided with a coating portion 81.

FIG. 12 illustrates the filter 9 used in the target supply device 7 according to the seventh exemplary embodiment.

The filter 9 may include a filter body 91 and a plurality of pass holes 92. The filter body 91 is a disc-shaped member, in which the pass holes 92 may be provided. Each of the pass holes 92 may include a first pass hole 92a and a second pass hole 92b. The first pass hole 92a may be open on the side near the tank. The second pass hole 92b may be open on the output side. The first pass hole 92a and the second pass hole 92b may be circular. The diameter of the first pass hole 92a may be larger than the diameter of the second pass hole 92b.

The material of the filter 9 may be the same as the material of the tank 71 and the nozzle 72, which may be selected from at least one of molybdenum (Mo) and tungsten (W) that exhibit a smaller corrosion depth of tin (Sn) (i.e. a depth of corrosion as a result of reaction with tin (Sn) to form an alloy) than that of stainless steel and the like.

The filter 9 may include a coating portion 82. The coating portion 82 may be provided all over the surface of the filter body 91 of the filter 9. The coating portion 82 may be provided on the surface of each of the first pass holes 92a and the second pass holes 92b.

When molybdenum (Mo) and/or tungsten (W) is selected as the material of the filter 9, silicon carbide (SiC) may be selected as the material of the coating portion 82 because silicon carbide has a linear expansion coefficient close to that of molybdenum (Mo) and tungsten (W), the corrosion depth of tin (Sn) to silicon carbide is zero and silicon carbide has corrosion resistance against tin (Sn) even at a high temperature.

The method for providing the coating portion 82 may be selected from any one of sputtering, CVD and plasma CVD.

When the first pass holes 92a and the second pass holes 92b are provided to the filter 9, the aspect ratio of the second pass hole 92b is preferably 2 or less. In the above configuration, the coating portion 82 may be provided on the filter 9 from both sides of the first pass hole 92a and the second pass hole 92b. In this manner, the coating film may be favorably easily provided also on the wall surface of the second pass holes 92b.

By providing the coating portions 81, 82, the possibility for molybdenum (Mo) or tungsten (W) (material of the tank 71, the nozzle 72 and the filter 9) to react with tin (Sn) (target) to form an alloy may be reduced.

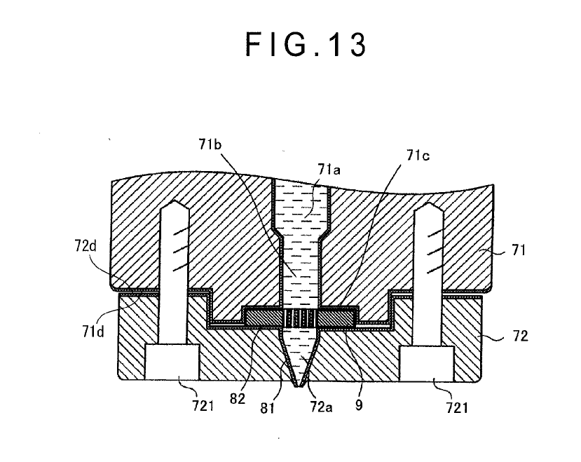

FIG. 13 illustrates a modification of the target supply device 7 according to the seventh exemplary embodiment.

In the target supply device 7 according to the modification, the surface of the supply portion 71b of the tank 71, a leading end surface 71d of the tank 71, the nozzle hole 72a of the nozzle 72, and a base end surface 72d of the nozzle 72 may be provided with the coating portion 81.

9. Target Supply Device Including Coated in-Tank Component

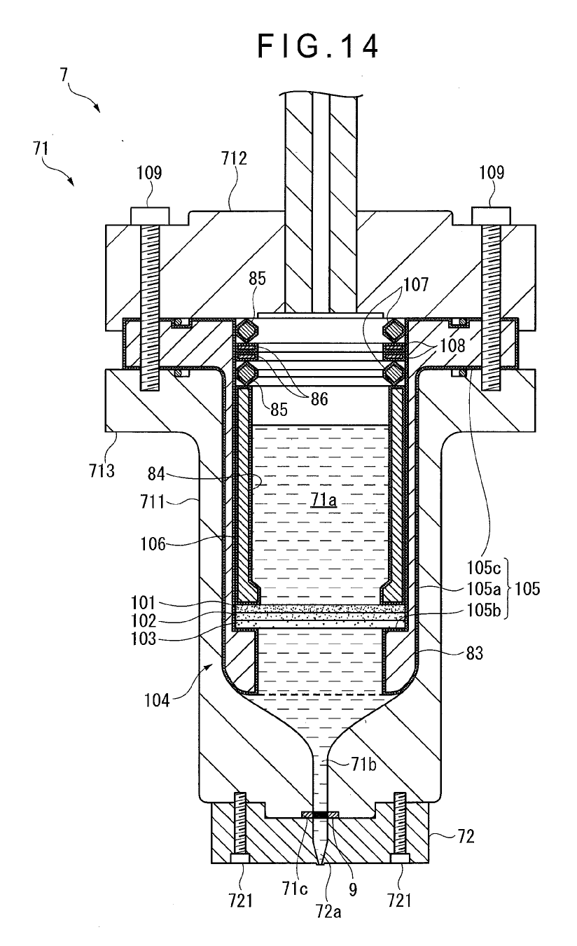

FIG. 14 illustrates the target supply device 7 according to an eighth exemplary embodiment.

The target supply device 7 may include the tank 71, the nozzle 72, the filter 9, a first porous filter 101, a second porous filter 102, a third porous filter 103, and a holder portion 104.

The tank 71 may include a tank body 711 and a cover 712.

A flange 713 that protrudes outward may be provided to a base end of the tank body 711 opposite the nozzle 72.

The filter 9 may be disposed in the recessed portion 71c of the tank 71. The tank 71 and the nozzle 72 may be fastened by the bolt 721 after the filter 9 is disposed. The surface of the supply portion 71b of the tank 71 and the surface of the nozzle hole 72a of the nozzle 72 may be provided with a coating portion (not shown).

The first, second and third porous filters 101, 102, 103 may each be made of a porous material in order to capture particles contained in the target material. The first porous filter 101 may be provided with numerous through-pores with a diameter of, for example, approximately 20 μm. The second porous filter 102 may be provided with numerous through-pores of which diameter is, for example, approximately 10 μm. The third porous filter 103 may be provided with numerous through-pores of which diameter is, for example, approximately 6 μm. As described above, the respective sizes of the through-pores of the first porous filter 101, the second porous filter 102, and the third porous filter 103 may be different. Further, the through-pores of the first, second and third porous filters 101, 102, 103 may each be bent in various directions to penetrate corresponding one of the porous filters.

The first, second and third porous filters 101, 102, 103 may each be made of a material that is unlikely to react with the target material. The difference between a linear thermal expansion coefficient of each of the first, second and third porous filters 101, 102, 103 and a linear thermal expansion coefficient of the tank 71 may be smaller than one fifth of the linear thermal expansion coefficient of the tank 71.

When the tank 71 is made of molybdenum (Mo) or tungsten (W), the first, second and third porous filters 101, 102, 103 may be made of one of the materials shown in Table 2 below.

TABLE 2

| | | | Linear |
|---|---|---|---|
| | | | Thermal |
| | | | Expansion |
| | | | Coefficient |
| Filter Type | Filter Structure | Material | [10⁻⁶/° C.] |
| Glass Porous | Porous Glass | Aluminum oxide | 6.0 |
| Filter | | Silicon-dioxide glass | |
| Ceramic Porous | Porous | Silicon carbide | 4.1 |
| Filter | Ceramics | Tungsten carbide | 5.2 |
| | | Aluminum nitride | 4.8 |
| | | Zirconium boride | 5.9 |
| | | Boron carbide | 5.4 |

The material of the first, second and third porous filters 101, 102, 103 may be, for example, shirasu porous glass (SPG) provided by SPG Technology Co., Ltd. SPG may be a porous glass that employs volcanic ash (shirasu) as a raw material. In the case where SPG is used as the material, the first, second and third porous filters 101, 102, 103 may be formed as a substantially circular plate.

The percentages of the components of SPG may be defined as shown in Table 3 below.

TABLE 3

| Component | SiO₂ | B₂O₃ | Al₂O₃ | NA₂O | CaO | MgO | K₂O |
|---|---|---|---|---|---|---|---|
| Percentage | 58 | 9 | 11 | 8 | 4 | 3 | 3 |

When the SPG is used as the material, the first, second and third porous filters 101, 102, 103 may be provided with numerous through-pores that have diameters in a range from 6 μm to 20 μm and are bent in various directions.

The holder portion 104 may include a body portion 105, a retainer 106, a spacer 107, a shim 108 and a bolt 109.

When the target material is liquid tin (Sn), the body portion 105, the retainer 106, the spacer 107 and the shim 108 may be made of molybdenum (Mo) or tungsten (W) that is unlikely to react with liquid tin (Sn).

The body portion 105, the retainer 106, the spacer 107 and the shim 108 may include coating portions 83, 84, 85, 86. The coating portions 83, 84, 85, 86 may be provided all over the surface of the body portion 105, the retainer 106, the spacer 107, and the shim 108, or, alternatively, only at a portion that would be in contact with the target material.

When molybdenum (Mo) and/or tungsten (W) is selected as the material of the body portion 105, the retainer 106, the spacer 107 and the shim 108, silicon carbide (SiC) may be selected as the material of the coating portions 83, 84, 85, 86 because silicon carbide has a linear expansion coefficient close to that of molybdenum (Mo) and tungsten (W), the corrosion depth of tin (Sn) to silicon carbide is zero and silicon carbide has corrosion resistance against tin (Sn) even at a high temperature.

The method for providing the coating portions 83, 84, 85, 86 may be selected from any one of sputtering, CVD and plasma CVD.

The body portion 105 may include a cylindrical portion 105a, a contact portion 105b and a flange 105c. The contact portion 105b may be provided at a leading end of the cylindrical portion 105a in a manner protruding toward an interior of the cylindrical portion 105a. The flange 105c may be provided at a base end of the cylindrical portion 105a in a manner protruding outward. The body portion 105 may be disposed in the tank body 711 so that the flange 105c is in contact with the flange 713 and the cylindrical portion 105a is housed in the storage portion 71a.

The first, second and third porous filters 101, 102, 103 may be disposed in the body portion 105 to be layered on one another. In the above, the first porous filter 101 may be disposed close to the base end while the third porous filter 103 is disposed close to the leading end.

The retainer 106 may be housed in the body portion 105. In the above, the retainer 106 may be in contact with the first porous filter 101 and an inner surface of the cylindrical portion 105a.

The spacer 107 may be formed of a substantially annular member. An outer diameter and inner diameter of the spacer 107 may be respectively substantially equal to an outer diameter and inner diameter of the shim 108. A vertical cross section of the spacer 107 may be polygonal or circular. For example, the vertical cross section of the spacer 107 may be substantially hexagonal.

For example, two spacers 107 and two shims 108 may be disposed at the base end of the retainer 106 in the body portion 105.

One of the spacers 107 may be disposed to be in line contact with the base end of the retainer 106.

The two shims 108 may be laid on the one of the spacers 107.

The other of the spacers 107 may be disposed to be in line contact with one of the shims 108. Further, the other of the spacers 107 may be disposed to be in line contact with the cover 712.

The bolt 109 may penetrate the cover 712 and the flange 105c of the body portion 105 to be screwed to the flange 713 of the tank body 711.

By providing the coating portions 83, 84, 85, 86, the possibility for molybdenum (Mo) or tungsten (W) (material of the body portion 105, retainer 106, spacer 107 and shim 108) to react with tin (Sn) (target) to form an alloy may be reduced.

The above-described exemplary embodiments and the modifications thereof are merely examples for implementing the present disclosure, and the present disclosure is not limited thereto. It would be obvious for those skilled in the art that various modifications may be made within the scope of the present disclosure.

The terms used in this specification and the appended claims should be interpreted as “non-limiting.” For example, the terms “include” and “be included” should be interpreted as “including the stated elements but not limited to the stated elements.” The term “have” should be interpreted as “having the stated elements but not limited to the stated elements.” Further, the modifier “one (a/an)” in the specification and claim(s) should be interpreted as “at least one” or “one or more.”

What is claimed is:

1. A target supply device comprising:
a tank including a storage portion that is configured to store a target material and a supply portion that is in communication with the storage portion so that the target material flows into the supply portion;
a nozzle including a nozzle hole that is in communication with the supply portion and is configured to be fed with the target material; and
a coating portion that covers a wall surface of the nozzle hole.

2. The target supply device according to claim 1, wherein the target material includes tin.

3. The target supply device according to claim 2, wherein the coating portion includes silicon carbide.

4. The target supply device according to claim 3, wherein the coating portion further covers a wall surface of the supply portion.

5. The target supply device according to claim 4, wherein the coating portion further covers a wall surface of the storage portion.

6. The target supply device according to claim 5, wherein the coating portion further covers an outer surface of the nozzle.

7. An extreme ultraviolet light generation apparatus comprising:
a chamber into which a laser light is introduced; and
a target supply device that is configured to output a target material into the chamber, the target supply device comprising:
a tank including a storage portion that is configured to store a target material and a supply portion that is in communication with the storage portion so that the target material flows into the supply portion;
a nozzle including a nozzle hole that is in communication with the supply portion and is configured to be fed with the target material; and
a coating portion that covers a wall surface of the nozzle hole.
